(19) United States
(12) Patent Application Publication
(10) Pub. No.: US 2026/0316090 A1
(43) Pub. Date: Oct. 15, 2026

(54) INSERTS FOR CENTRIFUGE ROTORS CONTAINER AND METHODS

(71) Applicants: THERMO ELECTRON SAS, Villebon-sur-Yvette (FR); FIBERLITE CENTRIFUGE LLC, Santa Clara, CA (US); THERMO ORION INC., Chelmsford, MA (US)

(72) Inventors: Benoit Jean LIMON, Villebon-sur-Yvette (FR); Sina PIRAMOON, Santa Clara, CA (US); KANNAN SRINIVASAN, Chelmsford, MA (US)

(21) Appl. No.: 19/484,550

(22) PCT Filed: May 15, 2024
(86) PCT No.: PCT/EP2024/063439

§ 371 Date: Nov. 14, 2025

(30) Foreign Application Priority Data
May 17, 2023 (EP) 23315205.7

(51) Int. Cl. B04B 5/04; B04B 7/12

(52) U.S. Cl. CPC B04B 5/0442; B04B 7/12; B04B 2005/0492

(57) ABSTRACT

An insert for a centrifuge rotor is provided. The insert is rotatable about an axis of rotation. The insert comprises: a plurality of container mountings for attaching a plurality of containers to the insert. Each container mounting comprises a corresponding first fluid passageway and a corresponding second fluid passageway. Each first fluid passageway comprises a first rotor port for delivering fluid to a container attached to the corresponding container mounting. Each second fluid passageway comprises a second rotor port for delivering fluid to a container attached to the corresponding container mounting, the second rotor port radially closer to the axis of rotation than the corresponding first rotor port. Fluid flow is inhibited in the second fluid passageways.

### BACKGROUND

The present disclosure relates to a centrifuge assembly, along with a corresponding system, method of operation and method of calibration.

It is known to use centrifuge systems to concentrate, wash and recover live cells from culture media and dead cells. These systems include a centrifuge which can be operated in both a counter-flow direction (fluid moves in an opposite direction to the centrifugal force) and an in-flow direction (fluid moves in the same direction as the centrifugal force).

In general even if this centrifuge includes a plurality of containers there is no consideration as to how flow through these containers may be controlled to allow the system to linearly scale up from an initial testing protocol which may have a single container. As a result, it can be difficult to predict the output of such a scaled-up process.

Further, the centrifuge typically includes first and second ports. To operate in the counter-flow direction fluid is fed into the first port and recovered from the second port, and to operate in the in-flow direction fluid is fed into the second port and recovered from the first port. To achieve this, the direction of fluid flow around the system is switched. Typically this will be by reversing a direction of a pump in the system.

As a result, each of the first port and the second port can effectively be an outlet port. This means that, for example, if measurement of the outlet is required there must be duplication of components and increased complexity.

U.S. Pat. No. 9,090,910 B2 discloses methods and systems for manipulation of media and particles, whether inert materials or biomaterials, such as cells in suspension cell culture. The methods and systems comprise use of an apparatus comprising a rotating chamber wherein actions of combined forces fluid flow force and centrifugal force form a fluidized bed within the rotating chamber. The arrangement uses a pump which is reversed to drive fluid through the centrifuge for cell concentration and washing. There is no disclosure of routing fluid flow through multiple containers to allow for linear scaling of a system.

U.S. Pat. No. 9,839,920 discloses an apparatus for manipulating particles which includes: a rotor rotatable at a speed about an axis, the rotor having an outer periphery and front and rear opposite sides; at least one chamber mounted on the rotor, each chamber having an inlet and an outlet; an umbilical assembly rotatable about the axis; and a drive mechanism configured to rotate the umbilical assembly at about one-half the speed of the rotor. The umbilical assembly includes: a curvilinear guide tube connecting to a drum at a rear side of the rotor; a flexible conduit residing in the guide tube; and first and second elongate passageways for each chamber extending through the conduit, wherein the first passageway is in fluid communication with the inlet of a respective chamber and the second passageway is in fluid communication with the outlet of the respective chamber.

The passageways are held in a spaced-apart relationship relative to one another. The arrangement uses a pump which is reversed to drive fluid through the centrifuge for cell concentration and washing. There is no disclosure of routing fluid flow through multiple containers to allow for linear scaling of a system.

US 2020 0297911 A1 discloses a chamber configuration for a reverse flow centrifuge, and a reverse flow centrifuge system configured for low fluid volume and small radius rotation. The compact reverse flow centrifuge system has a reusable subsystem and a single use replaceable subsystem. The replaceable subsystem comprises a separation chamber, fluid delivery manifold and rotational mounting connecting the separation chamber to the fluid manifold. The single use replaceable subsystem provides a closed environment for execution of reverse flow centrifugation processes. The separation chamber has a substantially conical fluid enclosure portion connected to a neck portion, and a dip tube extends centrally through the conical fluid enclosure to provide a fluid path to the tip of the conical fluid enclosure. There is no disclosure of routing fluid flow through multiple containers to allow for linear scaling of a system.

US 2021 0046489 A1 discloses a fluid recovery system and method for use with concentrator systems for concentrating particles suspended in a fluid and where this suspension is recovered from a fluid stream drawn from the concentrator system. A controller is configured to control valve actuation to direct concentrate being drawn from the concentrator chamber through a recovery tube to a recovery reservoir based on fluid volume movement. The system can use a density sensor to detect density transitions in fluid in the fluid recovery tube to identify leading and trailing edges of a portion of concentrated particles in fluid suspension passing through the recovery tube and actuate recovery valves based on objectives for maximising particle recovery with minimal dilution. There is no disclosure of routing fluid flow through multiple containers to allow for linear scaling of a system.

Examples of centrifuges include the Sartorius KSEP400. This centrifuge has up to four containers which are fed with one main feed pump and one harvest pump per container.

Another example centrifuge is the Invetech Korus in which there are up to two containers, with a separate feed pump for each container.

### SUMMARY

An insert for a centrifuge rotor is provided according to claim 1. While the present disclosure refers to an insert, it is noted that the insert may form the entirety of the rotor. In other words, the insert may be referred to as a rotor. The insert may be integral or unitary with other components of the rotor. Fluid flow may be inhibited in the second fluid passageways with respect to the first fluid passageways. This insert means that in an in-flow cell recovery stage fluid flow is inhibited to deliver a consistent recovery.

The fluid flow may be inhibited in the second fluid passageways by the second fluid passageways having a smaller cross-sectional area than the first fluid passageways. This is an effective way to inhibit fluid flow and thereby deliver consistent cell recovery.

The insert may further comprise a second central passageway in fluid connection with each second fluid passageway, wherein the second central passageway has a cross-sectional area greater than the cross-sectional area of each second fluid passageway. This is another effective way to inhibit fluid flow and thereby deliver consistent cell recovery.

There may be N second fluid passageways, and the cross-sectional area of each second fluid passageway may be within 10% of the cross-sectional area of the second central passageway divided by N. Effectively this distributes the flow across the second fluid passageways to balance pressure and fluid flow across the containers.

The insert may further comprise a first central passageway in fluid connection with each first fluid passageway, wherein a cross-sectional area of each first fluid passageway is within 10% of a cross-sectional area of the first central passageway. This means that in a counter-flow operation fluid is delivered to the containers for cell concentration.

The cross-sectional area of each first fluid passageway may be equal to the cross-sectional area of the first central passageway. This means that in a counter-flow operation fluid is delivered to the containers for cell concentration.

The first central passageway and the second central passageway may be concentric with one another. This is an effective design for delivering fluid to multiple passageways, particularly with a spinning rotor element. The two passageways may be concentric/co-axial and centred on the axis of rotation.

The insert may further comprise an intermittent flow distribution element configured to selectively direct fluid flow through at least one of the second fluid passageways and inhibit fluid flow through the other second fluid passageways. As fluid is delivered to each container in turn the cell recovery is balanced.

The plurality of container mountings may comprise three or more container mountings.

More container mountings allows for greater cell recovery as the system is linearly scaled. An insert for a centrifuge rotor is provided according to claim 10. With this insert fluid is delivered to the first container, and then progressively through each other container, then the second container and is then returned (counter-flow) or the reverse (in-flow). Again, this means that the system can be linearly scaled up from an initial test.

The plurality of container mountings may comprise three or more container mountings including the first container mounting and the second container mounting, wherein the first container mounting and the second container mounting are adjacent one another in a first direction, and a third container mounting is adjacent the first container mounting in a second direction opposite to the first direction. Fluid flows therefore flows through each container attached to the container mountings.

The first central passageway and the second central passageway may be concentric with one another. This is an effective design for delivering fluid to multiple passageways, particularly with a spinning rotor element. The two passageways may be concentric/co-axial and centred on the axis of rotation.

The plurality of container mountings are symmetrically arranged. This may be rotational symmetry and/or planar symmetry. This is convenient for a spinning rotor.

The plurality of container mountings may be rotationally symmetric about the axis of rotation. This is convenient for a spinning rotor.

The insert may further comprise a container attached to each container mounting to fluidically connect the first rotor port and the second rotor port. The containers complete the circuit and act as cell collection areas in the counter-flow regime.

A kit is provided according to claim 16. This kit allows for scaling up of the process. An insert with a first number of container mountings is used to develop a process, then the insert can be replaced with another insert with more container mountings.

A centrifuge or centrifuge assembly is provided according to claim 17. This centrifuge allows for the advantageous scaling described herein.

A method of operating this centrifuge or centrifuge assembly is provided according to claim 18. This method allows for counter-flow and in-flow regimes to be used with the advantageous centrifuge.

A container for a centrifuge or centrifuge assembly is provided according to claim 19. This container is particularly advantageous in set-ups where a single pump is used and allows for stable flow therethrough.

The head portion may be generally conical, with a base diameter greater than a diameter of the elongate stem. This geometry can help achieve stable flow distribution.

The diameter of the elongate stem may be between 20% to 30% of the base diameter. This geometry can help achieve stable flow distribution.

The head portion may have a cone angle between 70° and 105°, preferably between 70° and 85°. This geometry can help achieve stable flow distribution.

The head portion may comprise a first conical shape extending from the base to the apex, and a second conical shape tapering from the base to the elongate stem. This geometry can help achieve stable flow distribution.

The head portion may have a head portion length and the first conical shape may have a length which is at least 70% of the head portion length. This geometry can help achieve stable flow distribution.

The container may have a length, and the elongate stem has a length which is at least 40% of the length of the container. This geometry can help achieve stable flow distribution.

The elongate stem may have a length of at least 5 centimetres. This geometry can help achieve stable flow distribution.

The container may have a length, and the elongate stem may have a length which is at least 40% of the length of the container. This geometry can help achieve stable flow distribution.

The elongate stem may have a length of at least 5 centimetres. This is a suitable length for stable flow distribution.

A centrifuge or centrifuge assembly is provided according to claim 27. The single pump drives fluid into each of the containers, and the container shape allows for reliable processing using the centrifuge.

The centrifuge or centrifuge assembly may further comprise: an inlet port and an outlet port; valving configured to selectively fluidically connect: the inlet port with the first rotor port and the outlet port with a second rotor port in a first configuration of the valving; or the inlet port with the second rotor port and the outlet port with a first rotor port in a second configuration of the valving, wherein the pump is fluidically connected to the inlet port upstream of the valving. Such valving switches the centrifuge assembly between a counter-flow and an in-flow regime. Using these containers with a single pump can allow for even flow distribution of fluid through the system.

The pump may be the only pump in a flow loop defined between the outlet port and the inlet port. That is, there are no separate container pumps in the assembly. The claimed container allows for such an arrangement. Using these containers with a single pump can allow for even flow distribution of fluid through the system.

A method of operating the centrifuge or centrifuge assembly is provided according to claim 30. This method switches between counter-flow and in-flow regimes while only requiring a single pump.

### BRIEF DESCRIPTION OF THE DRAWINGS

The present specification makes reference to the accompanying drawings, by way of example only, in which:

FIGS. 1A to 1D show top cross-sectional schematics of inserts for centrifuge rotors with varying numbers of container mountings;

FIG. 2A shows a side cross-sectional view of an insert for a centrifuge rotor;

FIG. 2B shows a further side cross-sectional view of the insert for a centrifuge rotor of FIG. 2A in a close-up view;

FIG. 3 shows a top cross-sectional view of a central region of an insert for a centrifuge rotor;

FIG. 4A shows a top cross-sectional schematic of an insert for a centrifuge rotor;

FIG. 4B sows a further top cross-sectional schematic of the insert for a centrifuge rotor of FIG. 4A, the cross-section taken at a different height;

FIG. 5 shows a top cross-sectional schematic of a further insert for a centrifuge rotor;

FIG. 6A shows a top cross-sectional view of an insert for a centrifuge rotor having conventional containers attached thereto;

FIG. 6B shows a side cross-sectional view of the insert for a centrifuge rotor having conventional containers attached thereto of FIG. 6A;

FIG. 7A shows a top cross-sectional view of an insert for a centrifuge rotor having improved containers attached thereto;

FIG. 7B shows a side cross-sectional view of the insert for a centrifuge rotor having improved containers attached thereto of FIG. 7A;

FIG. 7C shows an isolated side partial cross-sectional view of an insert for a centrifuge rotor having an improved container attached thereto;

FIG. 8 shows a schematic of a centrifuge assembly; and

FIG. 9 shows a schematic of a system including the centrifuge assembly of FIG. 8.

### DETAILED DESCRIPTION

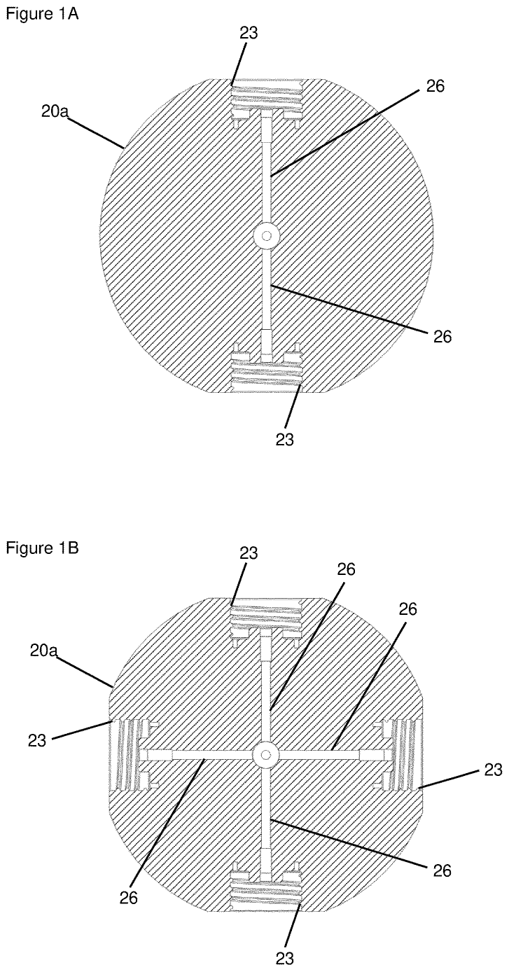

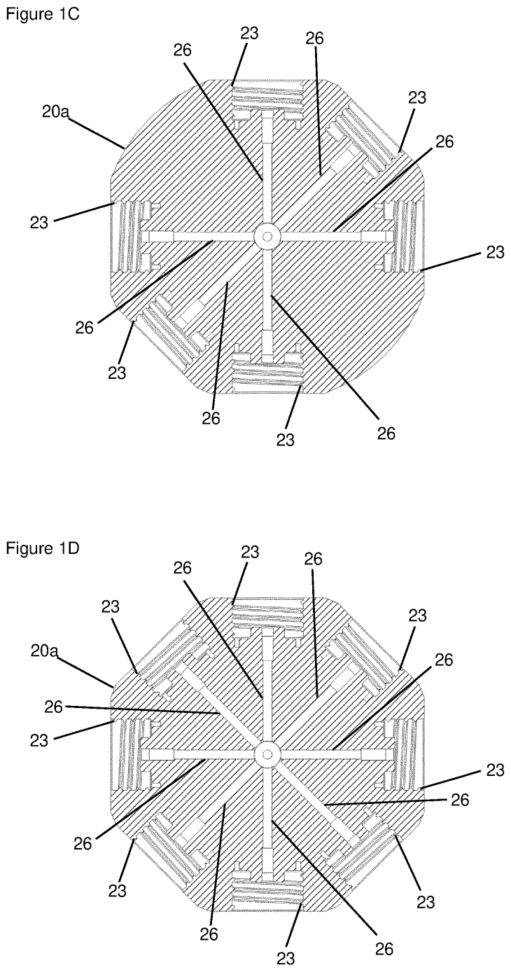

FIGS. 1A to 1D show a variety of rotor inserts 20a. These rotor inserts 20a can also be referred to as a rotor 20. The rotor inserts 20a may be inserted into further components to form the rotor 20, or the rotor inserts 20a may be the entire rotor 20.

Each rotor insert 20a comprises a plurality of container mountings 23. In certain examples, the plurality of container mountings 23 may be three or more container mountings 23. Each container mounting may comprise a corresponding first fluid passageway 26 and a corresponding second fluid passageway 27 (not shown in FIGS. 1A to 1D). Each first fluid passageway 26 comprises a first rotor port 24. This first rotor port 24 is suitable for delivering fluid to a container 25 attached to the container mounting 23. Each second fluid passageway 27 comprises a second rotor port 28. This second rotor port 28 is suitable for delivering fluid to a container 25 attached to the container mounting 23.

The second rotor port 28 is radially spaced from the first rotor port 24 with respect to the axis of rotation. In other words, one of the first rotor port 24 or the second rotor port 28 is closer to the axis of rotation than the other of the second rotor port 28 or the first rotor port 24. Specifically, the second rotor port 28 may be radially closer to the axis of rotation than the corresponding first rotor port 24.

In use, fluid may flow through the first fluid passageway 26, the first rotor port 24, then through the container 25 to the second rotor port 28 and the second fluid passageway 27. This can be identified as a counter-flow regime. Fluid can alternatively flow through the second fluid passageway 27, the second rotor port 28, then through the container 25 to the first rotor port 24 and the first fluid passageway 26. This can be identified as an in-flow regime.

The plurality of container mountings 23 may be arranged symmetrically about the rotor insert 20a. This may be rotational symmetry and/or planar symmetry. For example, with N container mountings 23 the rotor insert 20a may have N-fold rotational symmetry. FIGS. 1A to 1D show various example arrangements of container mountings 23 about a rotor insert 20a.

These multiple container mountings 23 are introduced to scale a process up which may have been developed on a much smaller scale, such as with a single container mounting 23. However, with multiple container mountings 23 and hence containers 25 it can be difficult to achieve uniform recovery. In order to achieve uniform recovery, fluid flow may be inhibited in the second fluid passageways 27. For example, the fluid flow may be inhibited in the second fluid passageways 27 with respect to the first fluid passageways 26.

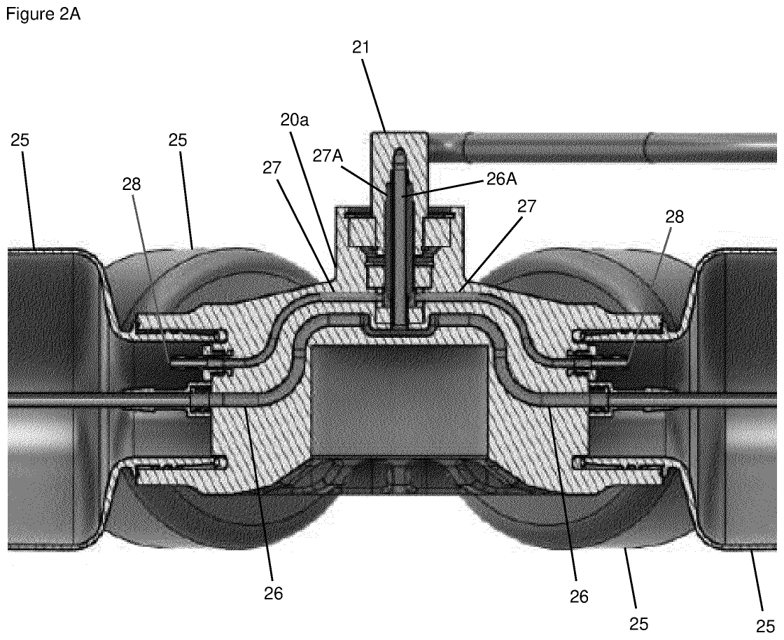

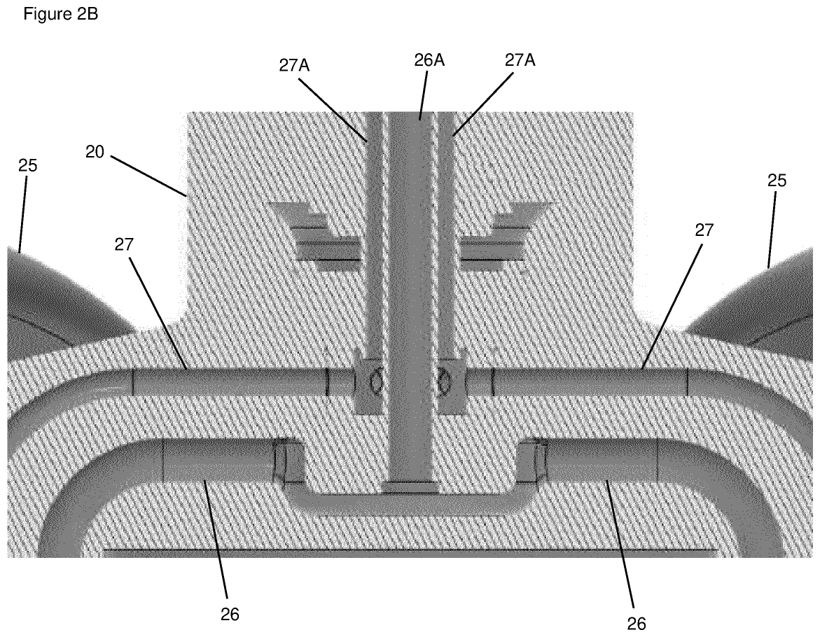

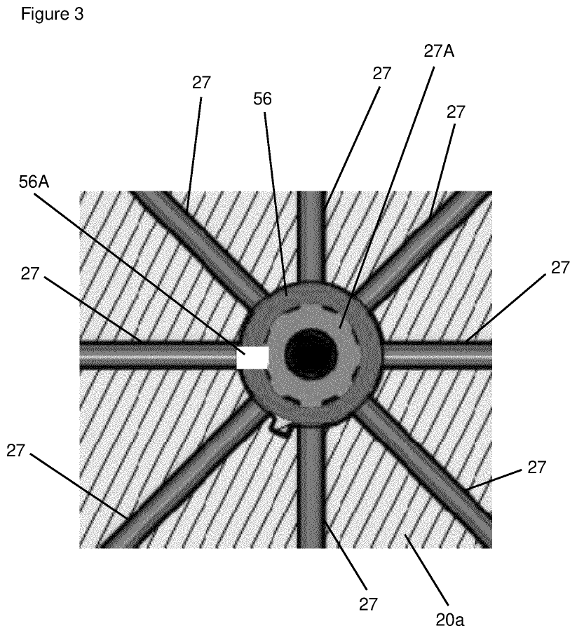

The inhibition of the fluid flow in the second fluid passageways 27 may be achieved in a number of ways. For example, this may be via flow restrictions achieved by selecting cross-sectional areas of the various flow pathways (FIGS. 2A to 2B). Alternatively, this may be by using an intermittent flow distribution element 56 (FIG. 3).

FIGS. 2A and 2B show how flow may be restricted by selecting cross-sectional areas of the various fluid pathways.

The insert 20a may further comprise a first central passageway 26A in fluid connection with each first fluid passageway 26. This first central passageway 26A may be generally static during rotation of the insert 20a. In use, fluid may flow through the first central passageway 26A and then from the first central passageway 26A to each first fluid passageway 26, and then into a container 25. This may be a counter-flow regime of the centrifuge 200. Fluid would then flow out of the container 25 via the corresponding second fluid passageway 27. In an in-flow regime fluid flow would be through the second fluid passageway 27, then the container 25, and then out of the container 25 via the corresponding first fluid passageway 26 and into the first central passageway 26A.

The first central passageway 26A has a first central cross-sectional area. This first central cross-sectional area may, for example, be defined by a diameter of the first central passageway 26A. Each of the first fluid passageways 26 has a first passageway cross-sectional area. Again, this may be defined by a diameter of each first fluid passageway 26. Each first passageway cross-sectional area may be generally similar to the first central cross-sectional area—such as within 10% of the first central cross-sectional area.

Specifically, they may be the same as one another. To achieve this, for example, each first passageway 26 may have a same diameter as the first central passageway 26A.

The insert 20a may comprise a second central passageway 27A. Of course, the reference to “second” in this context is for consistency of terminology with the second fluid passageways 27 and does not require the presence of any other central passageways. In other words, there may be a second central passageway 27A without there also being a first central passageway 26A.

The second central passageway 27A may be in fluid connection with each second fluid passageway 27. This second central passageway 27A may be generally static during rotation of the insert 20a. In use, fluid may flow through the second central passageway 27A and then into each second passageway 27. This flow may be into each second passageway 27 at the same time (as in FIG. 2A) or in an intermittent flow in which fluid flow is only through some of the second passageways 27 at a time (such as one second passageway as a time) as in FIG. 3. This direction of fluid flow may be an in-flow regime. As the fluid leaves the second passageway 27 it enters the container 25. The fluid would then flow through the corresponding first passageway 26 and out of the centrifuge 200. A counter-flow regime would be in an opposite direction as discussed above.

The second central passageway 27A has a second central cross-sectional area. This second central cross-sectional area may, for example, be defined by a diameter of the second central passageway 27A. Each of the second fluid passageways 27 has a second passageway cross-sectional area. Again, this may be defined by a diameter of each second fluid passageway 27.

Each second passageway cross-sectional area may be smaller than the first passageway cross-sectional area.

The second central cross-sectional area may be greater than the each second passageway cross-sectional area. This can therefore inhibit fluid flow in the second fluid passageways 27. In certain examples, the second central cross-sectional area may be “split” across the second fluid passageways 27. That is, if the second central cross-sectional area is A and there are N second fluid passageways, the second passageway cross-sectional area may be within 10% of A divided by N. The 10% allows for slight variations, such as manufacturing considerations in that certain sizes of second fluid passageways 27 may be easier to manufacture if they are standard sizes. For example, the second passageway cross-sectional area may be rounded up or down based on the diameter. This could be, for example, to the nearest 0.25 mm, 0.5 mm, 0.75 mm and/or 1 mm, or any other suitable size.

In a worked example, the second passageway cross-sectional area may be 9.75 TT mm² (approximately 30.63mm²). If there are six second fluid passageways 27, the second passageway cross-sectional area may be 1.625 TT mm² (approximately 5.11mm²). This would correspond (for cylindrical second fluid passageways 27) to a diameter of approximately 2.55 mm. Rounding to standard manufacturing sizes this may be rounded to a diameter of 2.5 mm as this may be a standard manufacturing size such as a standard drill-bit.

In certain examples, the first central passageway 26A and the second central passageway 27B may be co-axial and/or concentric with one another. In other words, one of the first central passageway 26A and the second central passageway 27A may be provided radially inwardly of the other. FIGS. 2A and 2B show the first central passageway 26A inside of the second central passageway 27A. In such cases, a cross-sectional area of the outer passageway may be defined based on both its outer diameter and its inner diameter.

For example, taking FIG. 2B the first central passageway 26A may have an outer diameter of 4 mm. The first central cross-sectional area would then be defined (π²) as 4π mm². The second central passageway 27A may have an outer diameter of 8 mm and an inner diameter of 5 mm. This would leave a 1 mm wall between the second central passageway 27A and the first central passageway 26A. The second central cross-sectional area would then be 16π mm²−6.25π mm²=9.75π mm².

In certain examples, the insert 20a may comprise a seal body 21 such as shown in FIG. 2A the insert 20a may rotate about the seal body 21. The combination of insert 20a and seal body 21 may be identified as a rotor 20. The first central passageway 26A and second central passageway 27A may be provided in the seal body 21. There may be a sealed interface between the first central passageway 26A and each first fluid passageway 26. Additionally, or alternatively, there may be a sealed interface between the second central passageway 27A and each second fluid passageway 27.

As a result of this arrangement, fluid flow in a counter-flow regime is not substantially restricted. This may mean that the flow is evenly acted on by g-forces in order to concentrate a same amount of cells in each container 25 with a same timing.

However, fluid flow in an in-flow regime is restricted. As a result, an even amount of fluid may be delivered to each container 25 in a cell recovery stage in order to recover cells from the container with a same timing.

An alternative, or additional, way to inhibit fluid flow is shown in FIG. 3 for a further rotor 20a. This may be used in combination with the cross-sectional areas of FIGS. 2A and 2B, or entirely separately thereto.

In this arrangement an intermittent flow distribution element 56 is provided. This is configured to selectively inhibit fluid flow in the second fluid passageways 27. For example, the intermittent flow distribution element 56 may only allow fluid flow through one or more of the second fluid passageways 27, and inhibit/block fluid flow through the remaining second fluid passageways 27. In this sense the intermittent flow distribution element 56 selectively directs fluid flow through the one or more second fluid passageways 27, and inhibits fluid flow through the other/remaining second fluid passageways 27.

FIG. 3 shows an example of such an intermittent flow distribution element 56. This is provided as a ring 56, surrounding a second central passageway 27A which is in fluid connection with each of the second fluid passageways 27. Other shapes of the intermittent flow distribution element 56 are also anticipated, but the following description will reference a ring 56. The ring 56 includes a gap 56A through which fluid can flow. The remaining body of the ring 56 acts to block between the second central passageway 27A and the second fluid passageways 27.

In this sense, when the gap 56A is aligned with one of the second fluid passageways 27 it forms a fluid flow path from the second central passageway 27A into the aligned second fluid passageway 27. The remaining second fluid passageways 27 are inhibited/blocked by the body of the ring 56.

In use, the rotor insert 20a spins about its axis of rotation in the centrifuge 200. This sequentially aligns each second fluid passageway 27 with the gap 56A. In this sense, fluid is delivered to each second fluid passageway 27 in order.

This intermittent flow distribution element 56 thereby acts to inhibit fluid flow in the second fluid passageways 27 by ensuring that fluid only flows into one second fluid passageway 27 at a time.

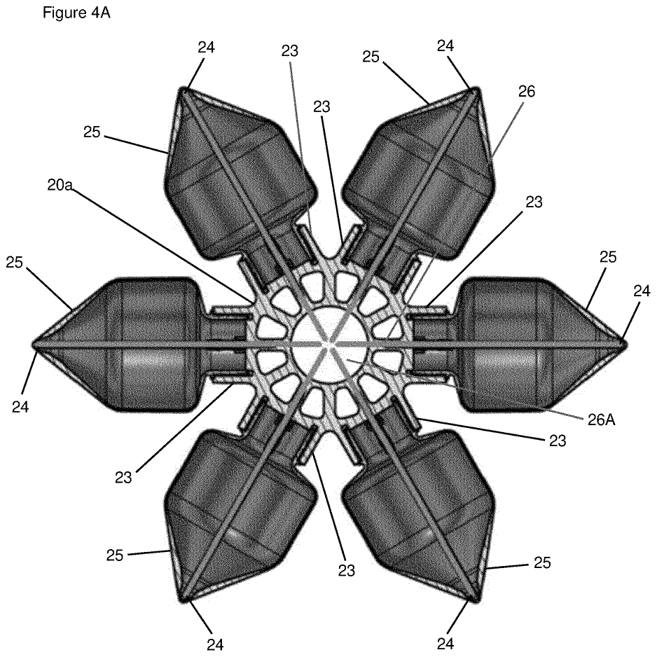

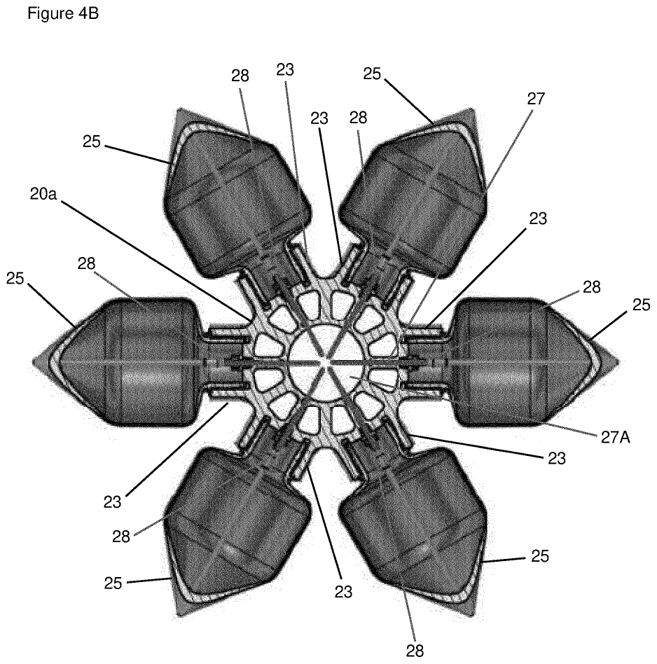

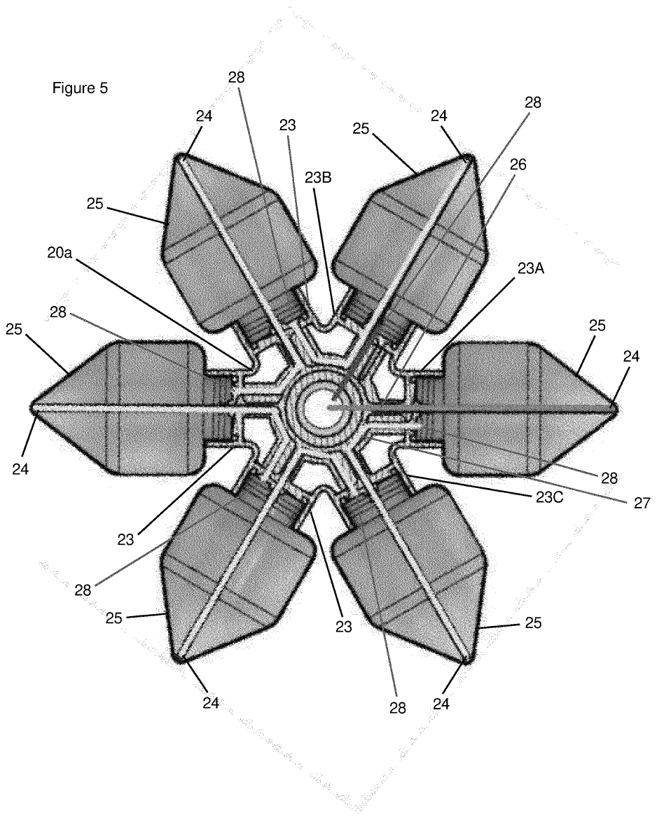

Any of the inserts 20a exhibiting this second fluid passageway 27 flow restriction mean that during an in-flow cell recovery stage there is even pressure and flow of fluid therethrough. Various arrangements for centrifuge inserts 20a which incorporate a plurality of container mountings 23 are shown in FIGS. 4A, 4B and 5.

FIGS. 4A and 4B show a centrifuge insert 20a which may be referred to as a “parallel” arrangement. FIG. 4B is taken at a different vertical position to FIG. 4A (i.e. in a direction into and out of the page). In the specific insert 20a shown in these Figures, FIG. 4B is vertically above (i.e. coming out of the page) when compared to FIG. 4A. This parallel arrangement may be the fluid flow arrangement used in the examples of FIGS. 2A, 2B and 3.

This insert 20a is rotatable about an axis of rotation, particularly when mounted in a centrifuge 200. The axis of rotation may extend into the page as shown in FIG. 4A, for example in a centre of the insert 20a.

The insert 20a includes a plurality of container mountings 23. Each container mounting 23 is suitable for attaching a container 25 thereto. This attaches the containers 25 to the insert 20a. The containers 25 may be attached to the container mountings 23 in any suitable manner, such a by threaded sections and/or press-fits.

The insert 20a of FIG. 4a has six container mountings 23, which six connected containers 25. However any number of container mountings 23 may be suitable, for example as shown in FIGS. 1A to 1D.

Each container mounting 23 comprises a corresponding first fluid passageway 26 (FIG. 4A) and a corresponding second fluid passageway 27 (FIG. 4B). The first fluid passageway 26 and/or second fluid passageway 27 may be generally as described above in relation to other Figures. Specifically unless otherwise explicitly mentioned any disclosure herein in relation to the other Figures is equally applicable to the insert 20a of FIGS. 4A and 4B.

The first fluid passageway 26 and second fluid passageway 27 deliver fluid to a container 25 connected to the corresponding container mounting 23. For example, each first fluid passageway 26 may comprise a first rotor port 24. Each second fluid passageway 27 may comprise a second rotor port 28. The second rotor port 28 may be radially closer to the axis of rotation of the rotor insert 20a than the first rotor port 24. In this sense, flow from the first rotor port 24 to the second rotor port 28 may be denoted as a counter-flow regime. Flow from the second rotor port 28 to the first rotor port 24 may be denoted as an in-flow regime.

The insert 20a may comprise a first central passageway 26A, which is in fluid connection to each first fluid passageway 26. As a result, fluid flowing into the first central passageway 26A is delivered to each first fluid passageway 26.

The insert 20a may comprise a second central passageway 27A, which is in fluid connection to each second fluid passageway 27. As a result, fluid flowing into the second central passageway 27A is delivered to each second fluid passageway 27. Although the second central passageway 27A is shown generally overlaying the first central passageway 26A, this is not necessarily the case. For example, the co-axial arrangement discussed above may be used.

In this sense, the insert 20a is referred to as a parallel arrangement as each container 25 is connected in parallel with the other containers 25. The second fluid passageway 27 may have flow restricted therein as described herein.

An alternative arrangement for an insert 20a is shown in FIG. 5. This arrangement may be referred to as a “serial” arrangement. Unless otherwise expressly set out this insert 20a is the same as the insert 20a of FIGS. 4A and 4B. In this arrangement, fluid flowing into the insert 20a flows into a first container 25, then from the first container 25 into a second container 25, before it is returned. In certain examples the fluid may progressively flow through each container 25 of the inset 20a.

To understand this, one of the plurality of container mountings 23 may be denoted as a first container mounting 23A and another of the plurality of container mountings 23 may be denoted as a second container mounting 23B. The first container mounting 23A and second container mounting 23B may be adjacent to one another in the plurality of container mountings 23. For example, in FIG. 5 they are adjacent in an anti-clockwise direction.

This could equally be in a clockwise direction. Again, in use a container 25 is attached to each container mounting 23. This attached container 25 fluidically connects the first rotor port 24 and second rotor port 28.

The first fluid passageway 26 of the first container mounting 23A extends to the first central passageway 26A. Fluid flowing into the first central passageway 26A therefore flows through this first fluid passageway 26 and into the container 25 attached to the first container mounting 23A.

The second fluid passageway 27 of the first container mounting 23A is then fluidically connected to the first fluid passageway 26 of an adjacent container mounting 23. This adjacent container mounting 23 may be adjacent to the first container mounting 23A in an opposite direction than the second container mounting 23B. For example, in FIG. 5 this is in the clockwise direction.

In examples with just two container mountings 23 then this adjacent container mounting 23 will be the second container mounting 23B. In examples with more than two container mountings 23, each container mounting 23 other than the second container mounting 23B may each have a second fluid passageway 27 which is fluidically connected to the first fluid passageway 26 of an adjacent container mounting 23. In this sense, a fluid flow path is formed into the first fluid passageway 26 of the first container mounting, then through each second fluid passageway 27 and first fluid passageway 26 of adjacent container mountings 23 in order.

This is until the second container mounting 23B is reached. The second fluid passageway 27 of the container mounting 23 adjacent to the second container mounting 23B is fluidically connected to the first fluid passageway 26 of the second container mounting 23B. However, the second container mounting 27 of the second container mounting 23B extends to a second central passageway 27B.

In this sense, a counter-flow regime may be defined by fluid delivered to the first central passageway 26A, then into the first fluid passageway 26 of the first container mounting 23A. This is followed by the second fluid passageway 27 of the first container mounting 23A and then the first fluid passageway 26 of an adjacent container mounting. This continues until the second container mounting 23B, where the second fluid passageway 27 flows into the second central passageway 27A. An in-flow regime would then be flow in an opposite direction.

The insert 20a may, for example, further comprise a third container mounting 23C. The first container mounting 23A and second container mounting 23B may be adjacent one another in a first direction (such as an anti-clockwise direction in FIG. 5). The third container mounting 23C may be adjacent the first container mounting 23A in a second direction opposite to the first direction (such as a clockwise direction in FIG. 5). Of course, the first direction may be clockwise and the second direction may be anti-clockwise.

For this insert 20a, the first central passageway 26A and the second central passageway 27A may be as described above. Specifically, they may be concentric/co-axial with one another.

The plurality of container mountings 23 may be arranged in any suitable manner. FIGS. 1A to 1D provide an example of potential container mounting 23 arrangements. For example, the container mountings 23 may be symmetrically arranged. This may be a rotational symmetry and/or a planar symmetry. In certain examples, with N container mountings 23 the container mountings 23 may be arranged with N-fold rotational symmetry.

Any of the inserts 20a may form a rotor 20. For example, this may be formed of the insert 20a and a seal body 21. Alternatively, the insert 20a may itself form the rotor 20. In any event, this rotor 20 is then rotationally mounted in a centrifuge 200 such that the rotor 20 is able to rotate about its axis of rotation. This allows the rotor 20 to be used in a centrifuge 200 process such as described herein.

Again, this serial arrangement can help ensure good cell recovery an in-flow regime.

All of the arrangements discussed herein thereby allow for a centrifuge process to be easily scaled up from an initial test without needing to change the separation parameters. For example, a test may be performed with one container 25 and the insert 20a spinning with 1000 g force. The live cells in this test may be elutriated at 0.5 litres/minute with a maximum capture capacity of 50,000,000 cells/millilitre. This can then be scaled up to a six container 25 insert 20a again spinning with 1000g force. For the parallel arrangement, the live cells may then be elutriated at 3 litres/minute (0.5 litres/minute×6 containers 25) with a total capture capacity of 300,000,000 cells/millilitre (50,000,000 cells/millilitre×6 containers 25). This linear scaling allows processes to be easily scaled up from an initial test.

Each of the inserts 20a disclosed herein can be used to form a rotor 20 in a centrifuge 200 as described herein. A kit can also be provided of the centrifuge 200 and a plurality of inserts 20a as disclosed herein. Each of these inserts 20a can have a different number of container mountings 23 to one another. This allows for a process to be easily scaled up using the kit by switching an insert 20a with a smaller number of container mountings 23 for an inset 20a with a greater number of container mountings 23.

A method of operating a centrifuge 200 incorporating any of these inserts 20a is therefore provided as follows. The rotor 20 is rotated about its axis of rotation. Fluid is then flowed into the insert 20a as described herein. For example, this flow may be first through each first fluid passageway 26, and then each first rotor port 24. This would be into a container 25. The fluid is then returned via each second rotor port 28 and second fluid passageway 27. This may be a counter-flow regime. The fluid may be flowed, for example, by using a pump 14 as described herein.

A direction of fluid flow may then be switched. For example this could be by using the valving 300 described herein. Fluid may then flow through the insert 20a in an in-flow regime. This flow may be first through each second fluid passageway 27, and then each second rotor port 28. This would be into a container 25. The fluid is then returned via each first rotor port 24 and first fluid passageway 26.

While various inserts 20a have been described herein which take advantage of using multiple container mountings 23 it has been noted that conventional containers 25 may perform sub-optimally with these inserts 20a, particularly when a single feed pump 14 is used.

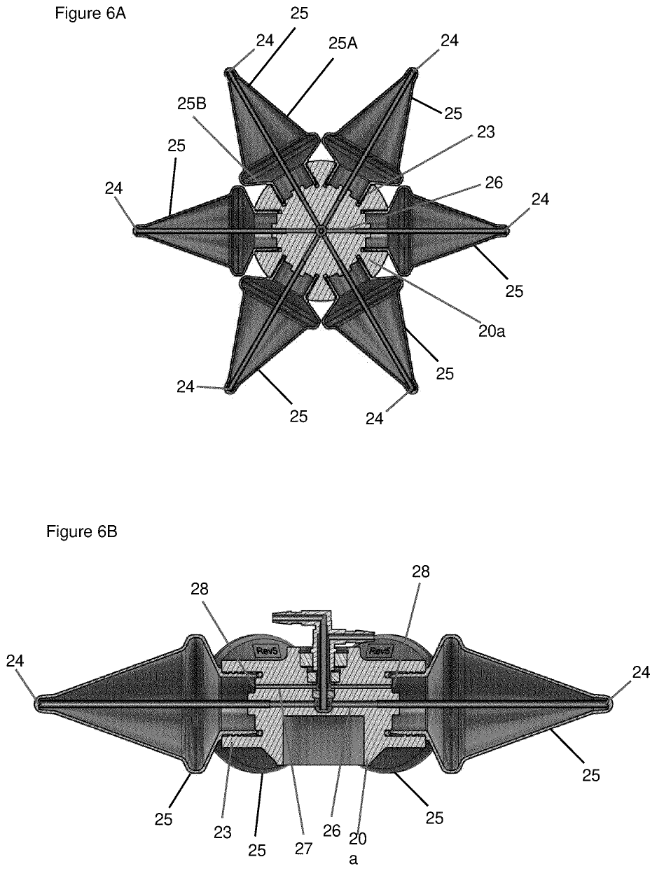

The inserts 20a may still use conventional containers 25 but performance of the system may be inhibited. FIGS. 6A and 6B show such an insert 20a with conventional containers 25 attached. These containers 25 are generally formed of a first conical shape 25A and a second conical shape 25B, connected at their bases. The first conical shape 25A and second conical shape 25B are denoted in FIG. 6A for one of the containers 25. The first conical shape 25A extends to a tip of the container 25. The second conical shape 25B extends away from the tip, and may for example be described as frustoconical. An attachment portion of the container 25 then extends from the second conical shape 25B away from the tip. The attachment portion may be a threaded section and/or a push-fit section.

This conventional container 25 may, however, perform sub-optimally for arrangements with multiple containers 25 being delivered with fluid from a single feed pump 14.

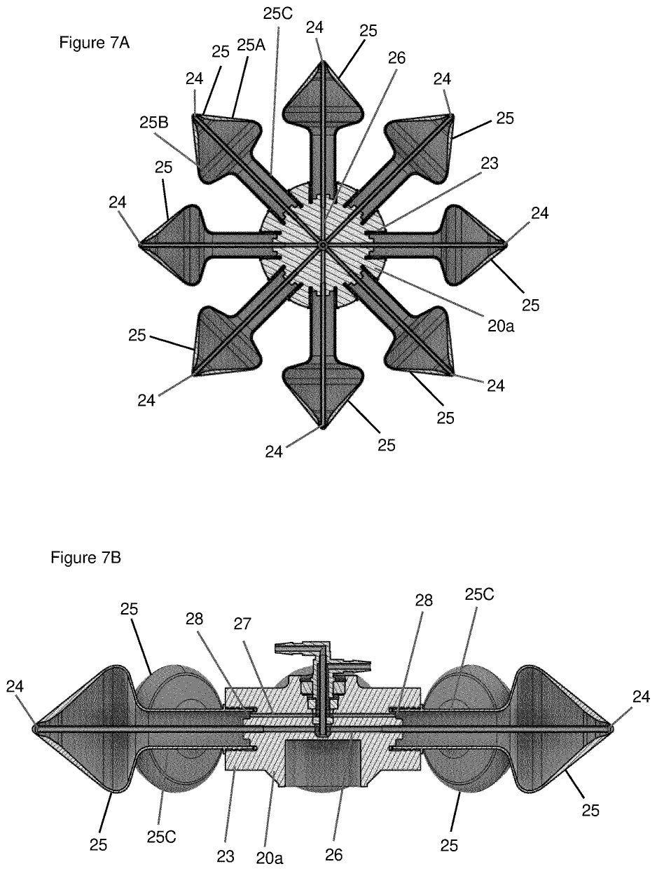

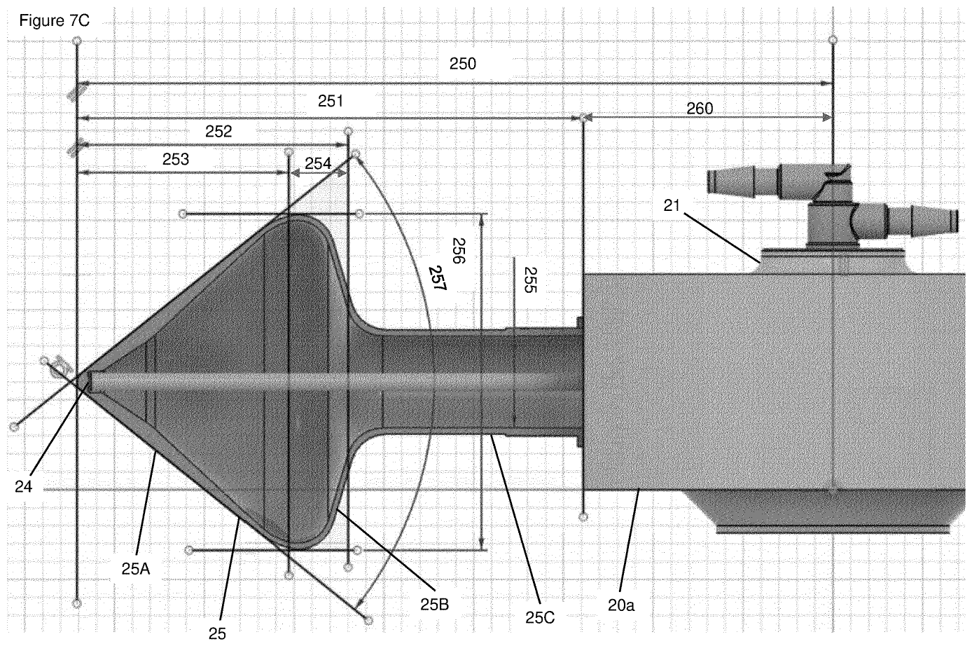

FIGS. 7A to 7C show improved containers 25 for such inserts 20a. FIG. 7A shows a top cross-sectional view of a rotor insert 20a and these improved containers 25, and FIG. 7B shows a side cross-sectional view of the rotor insert 20a and improved containers 25 of FIG. 7A.

FIG. 7C shows an isolated partial cross-sectional view of a rotor insert 20a and improved container 25. The improved container 25 of FIG. 7C may be the same as that shown in FIGS. 7A and 7B, or may differ therefrom. The cross-section of FIG. 7C is partial as only the container 25 is shown in cross-section, while the rotor insert 20a is not.

The container 25 comprises an elongate stem 25C and a head portion. The head portion is at a second end of the elongate stem 25C. A first end of the elongate stem 25C (opposite the second end) comprises an attachment portion of the container 25. The attachment portion is for attaching to a rotor 20 (either directly or via a rotor insert 20a). The head portion may be any suitable shape, but in general radially extends outwardly from the elongate stem 25C and then tapers to an apex away from the elongate stem 25C. In the example of FIGS. 7A to 7C the head comprises a first conical shape 25A and a second conical shape 25B. Such a head may be described as generally conical. A base of each conical shape 25A, 25B has a diameter greater than a diameter of the elongate stem 25C. In certain arrangements, there may be no second conical shape 25B, and the elongate stem 25C may directly contact a base of the first conical shape 25A.

The stem 25C is elongate in that it is longer than it is wide (i.e. its diameter). The container 25 may have a container length and the elongate stem 25C may extend at least 40% of the container length. The elongate stem 25C may have a greater length than the head, for example than the first conical shape 25A. In other words, the container 25 may have a container length and the elongate stem 25C may extend at least 50% of the container length. In this sense, the elongate stem 25C is much longer than the attachment portion of the conventional container of FIGS. 6A and 6B. For example, the elongate stem 25C may have a length of at least 5 centimetres.

This container 25 may be particularly useful in systems which have a single pump 14. Conventional systems will have a separate feed pump for each container. However, with a single pump 14 distribution of fluid flow into each container 25 may become unstable. The design of the improved containers 25 allows for stable flow even when a single pump 14 is used to supply fluid to all of the containers 25. This may be, for example, via any of the fluid passageways described herein.

FIG. 7C shows a particular container 25 which has been found to be particularly effective in such an arrangement. Unless otherwise specifically recited otherwise the container 25 is as described above in relation to FIGS. 7A and 7B.

The container 25 comprises an elongate stem 25C and a head portion. The head portion is at a second end of the elongate stem 25C. A first end of the elongate stem 25C (opposite the second end) comprises an attachment portion of the container 25. The attachment portion is for attaching to a rotor 20 (either directly or via a rotor insert 20a). The head portion of the container 25 in FIG. 7C comprises a first conical shape 25A and a second conical shape 25B. Such a head may be described as generally conical. A base of each conical shape 25A, 25B has a diameter greater than a diameter of the elongate stem 25C.

The head portion of the container 25 has a head length 252. This head length 252 may be between 40% to 60% of a total length of the container 25. In certain examples the head length 252 may be between 70 millimetres and 80 millimetres.

This head length 252 may be made up of a first conical length 253 corresponding to the length of the first conical shape 25A, and a second conical length 254 corresponding to the length of the second conical shape 25B. As noted above, the second conical length 254 may be zero (i.e. there is no second conical shape 25B) in certain examples.

In general, the first conical length 253 may be much greater than the second conical length 254. For example, the first conical length 253 may be 70% or greater of the head length 252. Additionally, or alternatively, the first conical length 253 may be less than 85% of the head length 252. The first conical length 253 may be in the region of 50 millimetres to 70 millimetres, for example between 55 millimetres and 60 millimetres.

The rest of the head length 252 is made up of the second conical length 254. This second conical length 254 may be up to 30% of the head length 252. Additionally, or alternatively, the second conical length 254 may be 15% or more of the head length 252. The second conical length 254 may be in the region of 10 millimetres to 20 millimetres.

The first conical shape 25A may have a cone angle 257. This cone angle 257 may be formed as a vertex angle made by a cross section through the apex of the first conical shape 25A and a centre of the base of the first conical shape 25A. The cone angle 257 may be between 70° and 105°, preferably between 70° and 85°, for example between 75° and 80°.

A base of the first conical shape 25A has a base width 256. This base width 256 may be between 150% and 160% of the first conical length 253. In certain examples, the base width 256 may be in region of 90 millimetres to 100 millimetres.

The elongate stem 25C of the container 25 has a stem length and a stem diameter 255.

The stem diameter 255 may be an inner diameter of the elongate stem 25C as this is the relevant diameter for the flow of fluid from the container 25. The stem diameter 255 may be in the region of 20% to 30% of the base width 256. In certain examples, the stem diameter 255 may be in the region of 20 millimetres to 30 millimetres.

FIG. 7C shows this container 25 attached to a rotor insert 20a. In this attached position, a radial extent 250 of the container 25 is defined. This is a measure from a centre of the rotor insert 20a (or indeed rotor 20) to an outermost point of the container 25. The rotor insert 20a itself has a rotor diameter 260 from the centre of the rotor insert 20a to an outermost part of the rotor insert 20a. This rotor diameter 260 may be in the region of 65 millimetres to 75 millimetres. The radial extent 250 of the container 25 may be defined with respect to this rotor diameter 260. For example, the radial extent 250 may be between 290% and 310% of the rotor diameter 260. In certain examples, the radial extent may be in the region of 200 millimetres to 220 millimetres. For example, between 205 and 215 millimetres. This leaves an exposed radius 251 of the container 25. This is the amount of the container 25 which is not inserted into the rotor insert 20a. The exposed radius 251 can be defined as the radial extent 250 with the rotor diameter 250 subtracted therefrom. The portion of the container 25 inserted into the rotor inset 20a may be defined an attachment portion of the container 25, such as a threaded section.

In this sense, a container 25 is provided which may be particularly beneficial for multi-container processing.

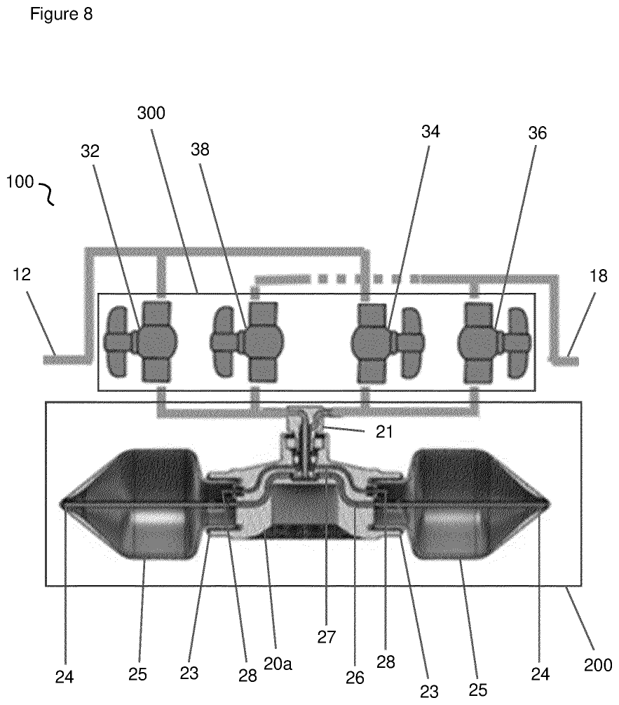

FIG. 8 shows an isolated schematic of the centrifuge assembly 100. This centrifuge assembly 100 is particularly relevant as the valving 300 described below allows fluid flow to be driven through the centrifuge assembly 100 in both a counter-flow regime and an in-flow regime with a single pump 14. This will be described in detail below. Thus, while the centrifuge assembly 100 shows conventional containers 25 being used it is noted that the improved containers 25 discussed herein may be particularly suitable for use with this centrifuge assembly 100.

While FIG. 8 shows the basic elements of the centrifuge assembly 100 it is appreciated that there may be additional components in this centrifuge assembly 100 which are not shown in FIG. 8.

The centrifuge assembly 100 comprises a rotor insert 20a. The rotor insert 20a may itself form a rotor 20. In certain examples, a combination of a rotor insert 20a and a seal body 21 may form the rotor 20. The rotor 20 is rotationally mounted about an axis of rotation. This axis of rotation may be anywhere appropriate for the rotor 20. In certain examples, this may be at a centre of the rotor 20 in plan view. For example, the rotor 20 may be generally circular in plan view, with the axis of rotation at a centre of the rotor 20. In any event, the rotor 20 is rotatable about this axis of rotation. This rotation can be driven by any suitable driving apparatus, such as an electric motor.

The rotor 20 may be rotationally mounted in this manner in a centrifuge 200. The rotor 20 may comprise one or more container mountings 23 for attaching a container 25 to the rotor 20. For example, the container mounting 23 may be a threaded element, with a corresponding threaded element on the container 25. FIG. 8 shows an example where the container mounting 23 is a female threaded section, and the container 25 has corresponding male threaded section. Of course, the threaded sections could be reversed. Any other suitable container mounting 23 may also be used, including but not limited to a push-fit connection, pin and bore, etc.

The rotor 20 comprises a first rotor port 24 and a second rotor port 28. Each of the first rotor port 24 and the second rotor port 28 are arranged to deliver a fluid to the container 25 when attached to the container mounting 23. The first rotor port 24 and second rotor 28 may, therefore, be identified as components of the container mounting 23. The second rotor port 28 is radially spaced from the first rotor port 24 with respect to the axis of rotation. In other words, one of the first rotor port 24 or the second rotor port 28 is closer to the axis of rotation than the other of the second rotor port 28 or the first rotor port 24.

FIG. 8 shows an example in which the first rotor port 24 is radially further from the axis of rotation than the second rotor port 28. In other words, the second rotor port 28 is radially closer to the axis of rotation than the first rotor port 24. An alternative arrangement is also considered with this reversed.

The rotor 20 may comprise a first fluid passageway 26. This first fluid passageway 26 can comprise the first rotor port 24. The rotor 20 may comprise a second fluid passageway 27. This second fluid passageway 27 can comprise the second rotor port 28.

In certain examples, fluid flow may be inhibited in the second fluid passageway(s) 27 with respect to the first fluid passageway(s) 26. For example, the second fluid passageway(s) 27 may have a smaller diameter than the first fluid passageway(s) 26.

Alternatively, or additionally, an intermittent flow distribution element may be provided. In this sense, fluid flow may be inhibited in the second fluid passageway(s) 27 by selectively preventing fluid flow through the second fluid passageway(s) 27 with the intermittent flow distribution element. This intermittent flow distribution element may be arranged in the second fluid passageway(s).

As can be seen in FIG. 8, the rotor 20 may comprise a plurality of container mountings 23. Each container mounting 23 is suitable for attaching a container 25 to the rotor 20.

Each container mounting 23 may have its own first rotor port 24 and second rotor port 28. The rotor 20 may comprise a first fluid passageway 26 and second fluid passageway 27 for each container mounting 23. The plurality of container mountings 23 may be connected in parallel in which each first fluid passageway 26 is connected directly to the inlet port 12 and each second fluid passageway 27 is connected directly to the outlet port 18.

In other configurations each container mounting 23 may be connected in series. The first fluid passageway 26 of the first container mounting 23 may be directly connected to the inlet port 12. The second fluid passageway 27 of the first container mounting 23 may be directly connected to the first fluid passageway 26 of an adjacent container mounting, and so on. The final container mounting 23 of the rotor has its second fluid passageway 26 in direct connection with the outlet port 18.

The following disclosure will refer to “the” first rotor port 24 and “the” second rotor port 28. However, it is equally applicable to an arrangement with multiple container mountings 23.

In such an arrangement the reference to “the” first rotor port 24 may correspond to “each” first rotor port 24, and the reference to “the” second rotor port 28 may correspond to “each” second rotor port 28.

The centrifuge assembly 100 comprises an inlet port 12 and an outlet port 18. The inlet port 12 and outlet port 18 may be dedicated connections, such as push-fit connections.

Alternatively, the inlet port 12 and outlet port 18 may be conceptional sections of pipework for the centrifuge assembly 100. The inlet port 12 receives a flow of fluid to pass into the rotor 20. The outlet port 18 expels a flow of fluid from the rotor 20.

The centrifuge assembly 100 further comprises valving 300. The valving 300 is selectively switchable between a first configuration and a second configuration.

In general, the valving 300 is for changing flow through the rotor 20 from a counter-flow regime and an in-flow regime. As the rotor 20 spins about the axis of rotation, a centrifugal force is experienced by fluid in containers 25 attached to the container mounting 23. This centrifugal force is in a radially-outward direction away from the axis of rotation. As noted, the first rotor port 24 and second rotor port 28 are radially spaced from one another. In use, fluid can flow from the radially-outer port (in FIG. 8 the first rotor port 24) to the radially-inner port (in FIG. 8 the second rotor port 28), which is identified as a counter-flow regime. Fluid can alternatively flow from the radially-inner port to the radially-outer port, which is identified as an in-flow regime. The following description of the flow regimes is on the basis of the radially-outer and -inner ports being as shown in FIG. 8, but is equally applicable to the opposite arrangement with the appropriate modifications.

The valving 300 is used to selectively route fluid flow which enters the inlet port 12 into either the first rotor port 24 (counter-flow regime) or the second rotor port 28 (in-flow regime) and hence into the container 25. The valving 300 is also used to correspondingly route fluid flow from the container 25 via the second rotor port 28 (counter-flow regime) or the first rotor port 24 (in-flow regime) to the outlet port 18. In other words, the same inlet port 12 and outlet port 18 can be used for both the counter-flow regime and the in-flow regime.

In the first configuration of the valving 300, the inlet port 12 is fluidically connected to the first rotor port 24, and the outlet port is fluidically connected to the second rotor port 28.

While the centrifuge assembly 100 may be used in an loop system in which all ports are ultimately fluidically connected about the loop, it is which of the first rotor port 24 and the second rotor port 28 that fluid flow into the inlet port 12 first is transmitted to.

The valving 300 may be any suitable configuration which achieves this switching between the first configuration and the second configuration. FIG. 8 shows one such example of suitable valving 300.

The valving 300 of FIG. 8 is made of first valving and second valving. The first valving selectively fluidically connects the inlet port 12 to either the first rotor port 24 or the second rotor port 28. The second valving fluidically connects the outlet port 18 to either the second rotor port 28 or the first rotor port 24. The second valving may connect to the other of the second rotor port 28 or first rotor port 24 than the first valving. That is, if the first valving is connecting the inlet port 12 to the first rotor port 24 then the second valving may connect the outlet port 18 to the second rotor port 28, or vice versa.

The first valving may comprise a first valve 32 and a second valve 34. The second valving may comprise a third valve 36 and a fourth valve 38. Each of these valves 32, 34, 36, 38 is able to inhibit/prevent fluid flow therethrough.

The first valve 32 is connected between the inlet port 12 and the first rotor port 24. The second valve 34 is connected between the inlet port 12 and the second rotor port 28. The third valve 36 is connected between the second rotor port 28 and the outlet port 18. The fourth valve 38 is connected between the first rotor port 24 and the outlet port 18.

In the first configuration, the first valve 32 is open and the second valve 34 is closed. This means that fluid flowing into the inlet port 12 is directed to the first rotor port 24. The third valve 36 is open and the fourth valve 38 is closed. This means that fluid flows into the second rotor port 28 and then out of the outlet port 18. This is the counter-flow regime.

In the second configuration, the first valve 32 is closed and the second valve 34 is open This means that fluid flowing into the inlet port 12 is directed to the second rotor port 28. The third valve 36 is closed and the fourth valve 38 is open. This means that fluid flows into the first rotor port 24 and then out of the outlet port 18. This is the in-flow regime.

While FIG. 8 shows each valve 32, 34, 36, 38 as being entirely independently operable, this is not necessarily the case. For example, there may be one or more components shared across multiple valve 32, 34, 36, 38. This could be for example an element which can block fluid flow through more than one valve 32, 34, 36, 38. For example, when the first valve 32 is opened this may simultaneously close the second valve 34 and/or the fourth valve 38. There may be, for example, a member which blocks fluid flow in the valves 32, 34, 36, 38. This member may be moved out of the way of fluid flow in the first valve 32 and into the flow path of fluid through the second valve 34 and/or the fourth valve 38.

In further examples, the first valving or second valving may comprise a valve with a single inlet and two outlets. Further example valving 300 may include one or more valves with multiple inputs and a single output. Such valving 300 can equally be used to achieve the switching of the present disclosure.

In this sense, a single inlet port 12 and a single outlet port 18 may be used. The inlet port 12 always acts as a fluid inlet, and the outlet port 18 always acts as a fluid outlet. However, the flow of fluid through the rotor 20 can be easily switched between a counter-flow regime and an in-flow regime. In this sense, fluid can be delivered to the centrifuge assembly 100 in a single direction (into the inlet port 12) and hence there is no need to reverse a direction of the fluid flow as in the prior art.

The centrifuge assembly 100 may further comprise a pump 14. This pump 14 can be of any suitable type. In particular examples, the pump 14 may be a non-contact pump whereby the mechanical parts of the pump 14 do not come into direct contact with fluid passing therethrough. For example, the pump 14 maybe a peristaltic pump (or roller pump) where one or more wipers or rollers progressive compress a flexible tube to drive fluid through the tube.

The pump 14 may be arranged upstream of the valving 300, connected (in certain examples with intermediate components) to the inlet port 12. By “upstream” it is meant that in an opposite direction to a flow of fluid through the centrifuge assembly 100. In other words, the fluid passes through the pump 14 and then the valving 300. As explained above, the valving 300 then acts to direct the flow of fluid in either a counter-flow regime or an in-flow regime through the rotor 20. As a result, the pump 14 can operate to pump fluid in a single direction (the downstream direction, towards the valving 300), while the valving 300 is used to change how that single direction of pumping is directed through the rotor 20. This allows the pump 14 to be configured to only drive the fluid in this single, downstream, direction. The pump 14 may be non-reversible, or at least configured such that in use it does not reverse.

A flow loop may be defined between the outlet port 18 and the inlet port 12, which does not include the valving 300 and/or rotor 20. This flow loop can be used to recirculate fluid to the rotor 20. In certain examples, the flow loop may include one or more reservoirs. In any event, the pump 14 may be the only pump 14 in this flow loop. In other words, there is no other pump arranged to drive fluid in an opposite direction to the pump 14.

In this sense, the pump 14 pumps in a single direction into the inlet port 12, and the valving 300 then handles routing of the fluid.

The centrifuge assembly 100 may further comprise a cell density sensor 68, arranged downstream of the valving 300. This may be, for example, downstream of the outlet port 18. The cell density sensor 68 may be fluidically connected to the outlet port 18. By “downstream” it is meant that in the direction of a flow of fluid through the centrifuge assembly 100. In other words, fluid flowing out of valving 300 and the outlet port 18 then flows through the cell density sensor 68.

This cell density sensor 68 is configured to measure a density of cells in fluid-the prevalence of cells being carried. This can be any suitable sensor, but two common examples are capacitance sensors or optical absorbance sensors. The optical absorbance sensor may be, for example, an ultraviolet (UV) absorbance sensor.

What may be particularly of importance is the density of live cells in the fluid. A capacitance sensor is able to identify only live cells, while an optical absorbance sensor detects all cells. Thus, the cell density sensor 68 may comprise both a capacitance sensor and an optical absorbance sensor, or just a capacitance sensor. Each of these arrangements is able to readily identify live cells in the fluid. Further examples are also possible with just an optical absorbance sensor.

Again, the arrangement of the centrifuge assembly 100 means that only a single cell density sensor 68 is required as all fluid leaving the outlet port 18 flows through the cell density sensor 68. As the valving 300 handles the routing the fluid flows in the same direction around the rest of the apparatus.

Again, a flow loop may be defined between the outlet port 18 and the inlet port 12, which does not include the valving 300 and/or rotor 20. This flow loop can be used to recirculate fluid to the rotor 20. In certain examples, the flow loop may include one or more reservoirs. In any event, the cell density sensor 68 may be the only cell density sensor 68 in this flow loop. In other words, there is no other cell density sensor which detects cell density upstream of the inlet port 12.

The centrifuge assembly 100 may further comprise a processor. This processor may be in communication with any of the components of the centrifuge assembly 100. Particularly, the processor may be in communication with the cell density sensor 68. The processor may receive a signal from the cell density sensor 68, the signal indicative of an amount of cells in the fluid at the cell density sensor 68. The processor may then adjust one or more operating parameters of the centrifuge assembly 100 in response to this signal.

The operating parameters may be any condition of the centrifuge assembly 100 in use. This could include the valving 300 and specifically which configuration of the first configuration or second configuration (or indeed any further configurations) it is placed in. The operating parameters may further include a fluid inlet rate to the inlet port 12 (which could, for example be controlled by varying an operational speed of a pump 14). The operating parameters may further include a rotational speed of the rotor 20. Each of these operating parameters may be varied as the centrifuge assembly 100 is used, and the processor can control this variation. The processor may additionally or alternatively adjust the operating parameters further based on the signal from the cell density sensor 68.

The centrifuge assembly 100 may be operated in the following method. The pump 14 is operated to pump fluid (product mixture) in a first direction. The valving 300 is in the first configuration. This means that the fluid is driven to the inlet port 12, and then the first rotor port 24 and then the second rotor port 28. From here the fluid then exits through the outlet port 18.

This may be a cell concentration stage. When the fluid contains a mixture of one or more of: live cells; dead cells; and/or culture medium this stage may capture live cells in the rotor 20, such as in container 25. Dead cells and/or culture medium may be elutriated from the rotor 20.

The valving 300 is switched from the first configuration to the second configuration.

The pump 14 continues to operate to pump fluid in the first direction. With the valving in the second configuration this means that the fluid is driven to the inlet port 12, and then the second rotor port 28 and then the first rotor port 24.

This may be a cell harvesting stage in which live cells are recovered from the rotor 20 to be harvested.

In examples with a cell density sensor 68, an output parameter of the fluid can be sensed. This output parameter may be indicative of an amount of cells in the fluid-particularly live cells. Operation of the centrifuge 200, valving 300 and/or pump 14 may be controlled based on the output parameter for either stage.

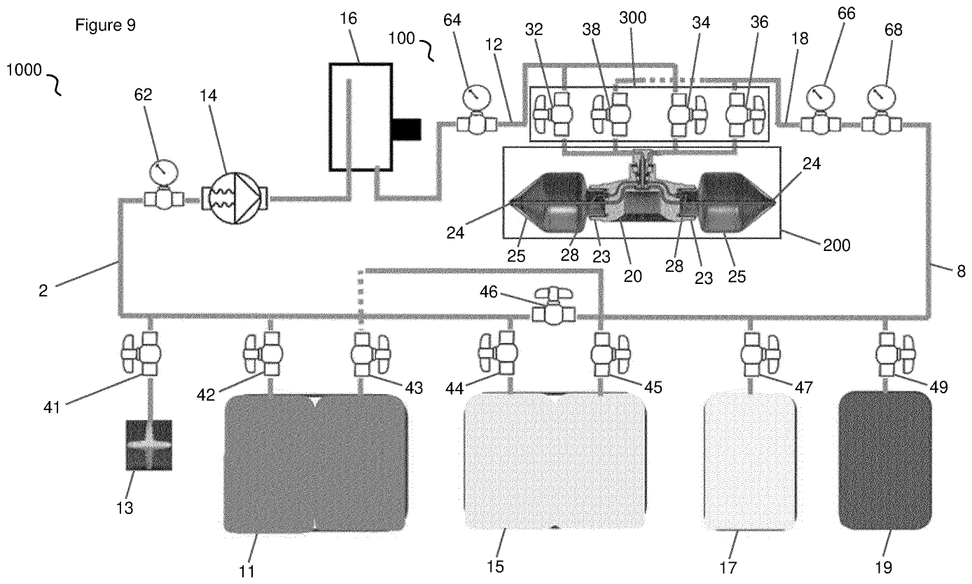

FIG. 9 shows a specific system 1000 which is set up to use the centrifuge assembly 100 of FIG. 8. Of course, any other centrifuge assembly 100 which uses valving 300 able to switch as described above may also be used. FIG. 9 does not show all of the reference numerals for the centrifuge assembly 100 given the scale of the Figure. Nevertheless, any feature or example of the centrifuge assembly 100 as described herein may be used with this system 1000.

The centrifuge assembly 100 of the system 1000 shown in FIG. 9 includes the pump 14 and cell density sensor 68. However as noted above these are not necessarily present in every example.

The system 1000 may comprise an inlet line 2 in fluid communication with the inlet port 12, upstream thereof. The system 1000 may further comprise an outlet line 8 in fluid communication with the outlet port 18, downstream thereof. The inlet line 2 and outlet line 8 may be entirely separate. In further examples such as the system 1000 of FIG. 9, the inlet line 2 and outlet line 8 may be separated by a cut-off valve 46. This cut-off valve 46 allows the inlet line 2 and outlet line 8 to be selectively isolated from one another. The pump 14 may be provided on the inlet line 2. The cell density sensor 68 may be provided on the outlet line 8.

The system 1000 may further comprise one or more reservoirs 11, 15, 17, 19. Each reservoir 11, 15, 17, 19 may have corresponding valves 42, 43, 44, 45, 47, 49 for controlling a flow of fluid into and/or out of the reservoir 11, 15, 17, 19. Each valve 42, 43, 44, 45, 47, 49 may selectively control fluid connectivity to the inlet line 2 and/or the outlet line 8. The system 1000 may include any combination of one or more of these reservoirs 11, 15, 17, 19.

A product reservoir 11 may be provided in the system 1000. The product reservoir 11 is used to supply a product to be processed by the system 1000. The product may include a mixture of one or more of live cells, culture media, and dead cells. One or more product valves 42, 43 may be provided for selectively controlling a flow of fluid into and/or out of the product reservoir 11. For example, system 1000 includes a product outlet valve 42 and a product inlet valve 43. The product outlet valve 42 controls a flow of product out of the product reservoir 11, for example into the inlet line 2 of the system 1000. The product inlet valve 43 controls a flow of fluid into the product reservoir 11, for example from the outlet line 8 of the system 1000.

A buffer reservoir 15 may be provided in the system 1000. The buffer reservoir 15 is used to supply a buffer fluid to the system 1000. One or more buffer valves 44, 45 may be provided for selectively controlling a flow of fluid into and/or out of the buffer reservoir 15. For example, system 1000 includes a buffer outlet valve 44 and a buffer inlet valve 45. The buffer outlet valve 44 controls a flow of buffer fluid out of the buffer reservoir 15, for example into the inlet line 2 of the system 1000. The buffer inlet valve 45 controls a flow of fluid into the buffer reservoir 15, for example from the outlet line 8 of the system 1000.

The system 1000 may comprise a harvest reservoir 17. The harvest reservoir 17 is to collect (or harvest) the treated product. A harvest valve 47 may be provided for selectively controlling a flow of fluid into the harvest reservoir 17. As the harvest reservoir 17 is for collecting the treated product it may be unnecessary to have a harvest outlet valve. The harvest valve 47 may be denoted a harvest inlet valve 47, and controls a flow of treated product into the harvest reservoir 17, for example from the outlet line 8 of the system 1000.

The system 1000 may comprise a waste reservoir 49. The waste reservoir 19 is to collect waste material from the process. A waste valve 49 may be provided for selectively controlling a flow of fluid into the waste reservoir 19. As the waste reservoir 19 is for collecting the waste material it may be unnecessary to have a waste outlet valve. The waste valve 49 may be denoted a waste inlet valve 49, and controls a flow of waste material into the waste reservoir 19, for example from the outlet line 8 of the system 1000.

In certain examples, the waste reservoir 19 and harvest reservoir 17 may be reversed depending on the desired product of the system 1000. That is, the material collected in waste reservoir 19 when the method discussed herein is performed may be the desired product of the system 1000.

The system 1000 may comprise an air inlet 13. The air inlet 13 may be, for example, an air pump or simply a connection to an external source of air such as an open air port. The air inlet 13 inlets air into the system 1000. This may be into the inlet line 2. This air inlet 13 may comprise a filter element to filter any air being inlet into the system 1000. This may specifically be a sterile filter. An air valve 41 may be provided between the air inlet 13 and the system 1000 to selectively control inlet of air into the system 1000.

As noted above, any combination of these reservoirs 11, 15, 17, 19 and/or air inlet 13 is contemplated and may be used for the system 1000 as appropriate.

A bubble trap 16 may also be provided in the system 1000. This bubble trap 16 may be provided in the inlet line 2. For example, the bubble trap 16 may be provided in the inlet line 2. Specifically the bubble trap 16 may be downstream of the pump 14 and upstream of the first inlet 12 and/or valving 300. That is, the bubble trap 16 may be between the pump 14 and the first inlet 12 and/or valving 300. The bubble trap 16 acts to remove any bubbles from fluid being moved around the system 1000. In certain examples the bubble trap 16 may vent to an external area. This could be controlled by a bubble valve (not shown). Vented bubbles may pass through a filter (also not shown).

The cell density sensor 68 is already discussed above. The system 1000 may comprise, in addition or alternatively, one or more further sensors. Again any combination of sensors is contemplated for the system 1000. Any of the provided sensors may be in communication with the processor of the centrifuge assembly 100. The processor may control the operating parameters of the centrifuge assembly 100 based on sensed data from any of the provided sensors.

For example, the system 1000 may comprise an air/liquid detector 62. The air/liquid detector 62 may be in the inlet line 2 of the system 1000. This could be located, for example, upstream of the pump 14. In certain examples the air/liquid detector 62 may be downstream of the air inlet 13. That is the air/liquid detector 62 may be between the air inlet 13 and pump 14. The air/liquid detector 62 is configured to determine that fluid is flowing through the system 1000, and whether there are air bubbles in said fluid.

A pressure sensor 64 may be provided in the system 1000. The pressure sensor 64 senses a pressure of fluid flowing in the system. The pressure sensor 64 may be in the inlet line 2 of the system. For example, the pressure sensor 64 may be downstream of the pump 14. In examples with a bubble trap 16, the pressure sensor 64 may be downstream of the bubble trap 16. The pressure sensor 64 may be upstream of the inlet port 12 and/or valving 300. In other words, the pressure sensor 64 may be between the pump 14 (and bubble trap 16) and the inlet port 12/valving 300.

A flow sensor 66 may be provided in the system 1000. The flow sensor 66 measures a parameter of fluid flow through the system 1000. For example, this may include one or more of: a flow velocity, flow rate (volumetric or mass) or any other parameter of the flow. The flow sensor 66 may be in the outlet line 8. The flow sensor 66 may be arranged, for example, downstream of the outlet port 18. In certain examples, the flow sensor 66 may be between the outlet port 18 and the cell density sensor 68. However this is not the only arrangement and the flow sensor 66 may be provided at any suitable location in the system 1000.

This system 1000 can be operated such that fluid is driven into the centrifuge assembly 100, such as by constant forward operation of the pump 14. The valving 300 then operates to route the fluid flow between a counter-flow regime and an in-flow regime. Thus the system 1000 can be used for complex processing. The improved containers 25 of FIGS. 7A to 7C can allow the system 1000 to be particularly effective even with a single pump 14.

It will be appreciated that embodiments of the disclosure may be implemented using a variety of different information processing systems. In particular, although the Figures and the discussion thereof provide exemplary computing systems and methods, these are presented merely to provide a useful reference in discussing various aspects of the disclosure. Embodiments may be carried out on any suitable data processing device, such as a personal computer, laptop, tablet, personal digital assistant, mobile telephone, smart phone, set top box, television, server computer, etc. Of course, the description of the systems and methods has been simplified for purposes of discussion, and they are just one of many different types of systems and methods that may be used. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAS), and/or one or more application-specific-integrated-circuits (ASICs), and/or one or more digital-signal-processors (DSPs), and/or other hardware arrangements. Method steps implemented in flowcharts contained herein, or as described above, may each be implemented by corresponding respective modules. Moreover, multiple method steps implemented in flowcharts contained herein, or as described above, may be implemented together by a single module.

It will be appreciated that, insofar as embodiments of the disclosure are implemented by a computer program, then a storage medium and a transmission medium carrying the computer program form aspects of the disclosure. The computer program may have one or more program instructions, or program code, that, when executed by a computer, causes an embodiment of the disclosure to be carried out. The term “program” as used herein, may be a sequence of instructions designed for execution on a computer system, and may include a subroutine, a function, a procedure, a module, an object method, an object implementation, an executable application, an applet, a servlet, source code, object code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a Blu-ray disc), or a memory (such as a ROM, a RAM, EEPROM, EPROM, Flash memory or a portable/removable memory device), etc. The transmission medium may be a communications signal, a data broadcast, a communications link between two or more computers, etc.

Each feature disclosed in this specification, unless stated otherwise, may be replaced by alternative features serving the same, equivalent, or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and, where the context allows, vice versa. For instance, unless the context indicates otherwise, a singular reference herein including in the claims, such as “a” or “an” (such as a component or an element) means “one or more” (for instance, one or more components, or one or more elements). Throughout the description and claims of this disclosure, the words “comprise”, “including”, “having” and “contain” and variations of the words, for example “comprising” and “comprises” or similar, mean that the described feature includes the additional features that follow, and are not intended to (and do not) exclude the presence of other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

Any steps described in this specification may be performed in any order or simultaneously unless stated or the context requires otherwise. Moreover, where a step is described as being performed after a step, this does not preclude intervening steps being performed.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

A method of manufacturing and/or operating any of the devices disclosed herein is also provided. The method may comprise steps of providing each of the features disclosed and/or configuring or using the respective feature for its stated function.

### CLAUSES

1. An insert for a centrifuge rotor rotatable about an axis of rotation, the insert comprising:
a plurality of container mountings for attaching a plurality of containers to the insert, each container mounting comprising a corresponding first fluid passageway and a corresponding second fluid passageway, wherein:
each first fluid passageway comprises a first rotor port for delivering fluid to a container attached to the corresponding container mounting;
each second fluid passageway comprises a second rotor port for delivering fluid to a container attached to the corresponding container mounting, the second rotor port radially closer to the axis of rotation than the corresponding first rotor port; and
fluid flow is inhibited in the second fluid passageways.

2. The insert of clause 1, wherein the fluid flow is inhibited in the second fluid passageways by the second fluid passageways having a smaller cross-sectional area than the first fluid passageways.

3. The insert of any preceding clause, further comprising a second central passageway in fluid connection with each second fluid passageway, wherein the second central passageway has a cross-sectional area greater than the cross-sectional area of each second fluid passageway.

4. The insert of clause 3, wherein there are N second fluid passageways, and the cross-sectional area of each second fluid passageway is within 10% of the cross-sectional area of the second central passageway divided by N.

5. The insert of any preceding clause, further comprising a first central passageway in fluid connection with each first fluid passageway, wherein a cross-sectional area of each first fluid passageway is within 10% of a cross-sectional area of the first central passageway.

6. The insert of clause 5, wherein the cross-sectional area of each first fluid passageway is equal to the cross-sectional area of the first central passageway.

7. The insert of clause 5 or 6, when dependent on clause 3, wherein the first central passageway and the second central passageway are concentric with one another.

8. The insert of clause 1, further comprising an intermittent flow distribution element configured to inhibit fluid flow in the second fluid passageways by selectively direct fluid flow through at least one of the second fluid passageways and inhibit fluid flow through the other second fluid passageways.

9. The insert of any preceding clause, wherein the plurality of container mountings comprises three or more container mountings.

10. An insert for a centrifuge rotor rotatable about an axis of rotation, the insert comprising:
a plurality of container mountings for attaching a plurality of containers to the insert, comprising at least a first container mounting and a second container mounting, each container mounting comprising a corresponding first fluid passageway and a corresponding second fluid passageway, wherein:
each first fluid passageway comprises a first rotor port for delivering fluid to a container attached to the corresponding container mounting;
each second fluid passageway comprises a second rotor port for delivering fluid to a container attached to the corresponding container mounting, the second rotor port radially closer to the axis of rotation than the corresponding first rotor port;
the first fluid passageway of the first container mounting extends to a centre of the insert for receiving fluid from or delivering fluid to a first central passageway;
the second fluid passageway of the second container mounting extends to a centre of the insert for delivering fluid to or receiving fluid from a second central passageway; and
the second fluid passageway of each container mounting other than the second container mounting is fluidically connected to the first fluid passageway of an adjacent container mounting.

11. The insert of clause 10, wherein the plurality of container mountings comprises three or more container mountings including the first container mounting and the second container mounting, wherein the first container mounting and the second container mounting are adjacent one another in a first direction, and a third container mounting is adjacent the first container mounting in a second direction opposite to the first direction.

12. The insert of clause 10 or 11, wherein the first central passageway and the second central passageway are concentric with one another.

13. The insert of any preceding clause, wherein the plurality of container mountings are symmetrically arranged.

14. The insert of clause 13, wherein the plurality of container mountings are rotationally symmetric.

15. The insert of any preceding clause, further comprising a container attached to each container mounting to fluidically connect the first rotor port and the second rotor port.

16. A kit comprising:
a centrifuge comprising a rotor for receiving an insert of any preceding clause; and
a plurality of inserts according to any preceding clause, each insert having a different number of container mountings.

17. A centrifuge comprising:
a rotor receiving the insert of any of clauses 1 to 15, the rotor rotationally mounted in the centrifuge.

18. A method of operating the centrifuge of clause 17, the method comprising:
rotating the rotor;
flowing a fluid through each first fluid passageway and each first rotor port and then out of each second rotor port and second fluid passageway;
switching a flow direction of fluid; and
flowing a fluid through each second fluid passageway and each second rotor port and then out of each first rotor port and first fluid passageway.

19. A container for a centrifuge comprising:
an elongate stem comprising a first end for attaching to a rotor, and a second opposite end;
a head portion at the second end of the elongate stem, the head portion radially extending outwardly from the elongate stem and tapering to a point away from the elongate stem.

20. The container of clause 19, wherein the head portion is generally conical tapering from a base to an apex away from the elongate stem, with a base diameter greater than a diameter of the elongate stem.

21. The container of clause 20, wherein the diameter of the elongate stem is between 20% to 30% of the base diameter.

22. The container of clause 20 or 21, wherein the head portion has a cone angle between 70° and 105°, preferably between 70° and 85°.

23. The container of any of clauses 20 to 22, wherein the head portion comprises a first conical shape extending from the base to the apex, and a second conical shape tapering from the base to the elongate stem.

24. The container of any of clauses 20 to 23, wherein the head portion has a head portion length and the first conical shape has a length which is at least 70% of the head portion length.

25. The container of any of clauses 19 to 24, wherein the container has a length, and the elongate stem has a length which is at least 40% of the length of the container.

26. The container of any of clauses 19 to 25, wherein the elongate stem has a length of at least 5 centimetres.

27. A centrifuge assembly comprising:
a rotor, rotationally mounted about an axis of rotation, the rotor comprising a plurality of container mountings for attaching a plurality of containers to the insert, each container mounting comprising a corresponding first fluid passageway and a corresponding second fluid passageway, wherein: each first fluid passageway comprises a first rotor port for delivering fluid to a container attached to the corresponding container mounting; and each second fluid passageway comprises a second rotor port for delivering fluid to a container attached to the corresponding container mounting, the second rotor port radially spaced from the first rotor port with respect to the axis of rotation;
a plurality of containers according to any of clauses 19 to 26, each container attached to one of the container mountings; and
a pump fluidically connected to drive fluid through each of the first rotor ports or each of the second rotor ports. 28. The centrifuge assembly of clause 27, further comprising:
an inlet port and an outlet port;
valving configured to selectively fluidically connect:
   the inlet port with the first rotor port and the outlet port with a second rotor port in a first configuration of the valving; or
   the inlet port with the second rotor port and the outlet port with a first rotor port in a second configuration of the valving,
      wherein the pump is fluidically connected to the inlet port upstream of the valving.

29. The centrifuge assembly of clause 28, wherein the pump is the only pump in a flow loop defined between the outlet port and the inlet port.

30. A method of operating the centrifuge assembly according to any of clauses 28 to 29, the method comprising:
operating the pump in a first direction with the valving in the first configuration to drive fluid to the inlet port then the first rotor port and then the second rotor port;
switching the valving from the first configuration to the second configuration; and
operating the pump in the first direction with the valving in the second configuration to drive fluid to the inlet port then the second rotor port and then the first rotor port.

1. An insert for a centrifuge rotor rotatable about an axis of rotation, the insert comprising:
a plurality of container mountings for attaching a plurality of containers to the insert, each container mounting comprising a corresponding first fluid passageway and a corresponding second fluid passageway, wherein:
each first fluid passageway comprises a first rotor port for delivering fluid to a container attached to the corresponding container mounting;
each second fluid passageway comprises a second rotor port for delivering fluid to a container attached to the corresponding container mounting, the second rotor port radially closer to the axis of rotation than the corresponding first rotor port; and
fluid flow is inhibited in the second fluid passageways.

2. The insert of claim 1, wherein the fluid flow is inhibited in the second fluid passageways by the second fluid passageways having a smaller cross-sectional area than the first fluid passageways.

3. The insert of claim 2, further comprising a second central passageway in fluid connection with each second fluid passageway, wherein the second central passageway has a cross-sectional area greater than the cross-sectional area of each second fluid passageway.

4. The insert of claim 3, wherein there are N second fluid passageways, and the cross-sectional area of each second fluid passageway is within 10% of the cross-sectional area of the second central passageway divided by N.

5. The insert of claim 1, further comprising a first central passageway in fluid connection with each first fluid passageway, wherein a cross-sectional area of each first fluid passageway is within 10% of a cross-sectional area of the first central passageway.

6. The insert of claim 5, wherein the cross-sectional area of each first fluid passageway is equal to the cross-sectional area of the first central passageway.

7. The insert of claim 5, further comprising a second central passageway in fluid connection with each second fluid passageway, wherein the first central passageway and the second central passageway are concentric with one another.

8. The insert of claim 1, further comprising an intermittent flow distribution element configured to inhibit fluid flow in the second fluid passageways by selectively direct fluid flow through at least one of the second fluid passageways and inhibit fluid flow through the other second fluid passageways.

9. The insert of claim 1, wherein the plurality of container mountings comprises three or more container mountings.

10. An insert for a centrifuge rotor rotatable about an axis of rotation, the insert comprising:
a plurality of container mountings for attaching a plurality of containers to the insert, comprising at least a first container mounting and a second container mounting, each container mounting comprising a corresponding first fluid passageway and a corresponding second fluid passageway,
wherein:
each first fluid passageway comprises a first rotor port for delivering fluid to a container attached to the corresponding container mounting;
each second fluid passageway comprises a second rotor port for delivering fluid to a container attached to the corresponding container mounting, the second rotor port radially closer to the axis of rotation than the corresponding first rotor port;
the first fluid passageway of the first container mounting extends to a centre of the insert for receiving fluid from or delivering fluid to a first central passageway;
the second fluid passageway of the second container mounting extends to a centre of the insert for delivering fluid to or receiving fluid from a second central passageway; and
the second fluid passageway of each container mounting other than the second container mounting is fluidically connected to the first fluid passageway of an adjacent container mounting.

11. The insert of claim 10, wherein the plurality of container mountings comprises three or more container mountings including the first container mounting and the second container mounting, wherein the first container mounting and the second container mounting are adjacent one another in a first direction, and a third container mounting is adjacent the first container mounting in a second direction opposite to the first direction.

12. The insert of claim 10 wherein the first central passageway and the second central passageway are concentric with one another.

13. The insert of claim 10, wherein the plurality of container mountings are symmetrically arranged.

14. The insert of claim 13, wherein the plurality of container mountings are rotationally symmetric.

15. The insert of claim 10, further comprising a container attached to each container mounting to fluidically connect the first rotor port and the second rotor port.

16. A kit comprising:
a centrifuge comprising a rotor for receiving an insert of claim 10; and
a plurality of inserts according to any preceding claim, each insert having a different number of container mountings.

17. A centrifuge comprising:
a rotor receiving the insert of claim 1, the rotor rotationally mounted in the centrifuge.

18. A method of operating the centrifuge of claim 17, the method comprising:
rotating the rotor;
flowing a fluid through each first fluid passageway and each first rotor port and then out of each second rotor port and second fluid passageway;
switching a flow direction of fluid; and
flowing a fluid through each second fluid passageway and each second rotor port and then out of each first rotor port and first fluid passageway.

19. A container for a centrifuge comprising:
an elongate stem comprising a first end for attaching to a rotor, and a second opposite end;
a head portion at the second end of the elongate stem, the head portion radially extending outwardly from the elongate stem and tapering to a point away from the elongate stem.

20. The container of claim 19, wherein the head portion is generally conical tapering from a base to an apex away from the elongate stem, with a base diameter greater than a diameter of the elongate stem.

21-30. (canceled)
